(19) United States
(12) Patent Application Publication
(10) Pub. No.: US 2008/0198164 A1
(43) Pub. Date: Aug. 21, 2008

(54) Method and apparatus for conducting presentations

(76) Inventors: Claudia Cuttress, Etobicoke (CA); Michael Fullan, Toronto (CA)

Correspondence Address: THE WEBB LAW FIRM, P.C., 700 KOPPERS BUILDING, 436 SEVENTH AVENUE, PITTSBURGH, PA, 15219, US

(21) Appl. No.: 11/706,577

(22) Filed: Feb. 15, 2007

(51) Int. Cl. G06T 11/00

(52) U.S. Cl. 345/467

(57) ABSTRACT

A method of managing a document presentation comprising presenting a document image to the audience on a display apparatus, positioning a timer image on the display apparatus so that the timer image overlays the document image at least partially, and so that the timer image is configured to be noticeably visible to the audience, selecting a timer count duration to match a preselected duration of an audience group activity, initiating a count of the timer, updating the timer image in accordance with the count.

### FIELD OF THE INVENTION

This invention relates to the field of education and of management training, and in particular, to the field of group seminars, workshops and classroom situations for leadership training and for the teaching of students in classrooms.

### BACKGROUND OF THE INVENTION

Seminars are a widely used method of educating adults. The uses of seminars include university course work, and continuing education for professionals and staff already in the work force.

One type of learning method that is widely used, and growing in popularity, is called “cooperative learning”. Cooperative learning includes both classroom instruction and allotted time for group activities. For example, a number of students receiving management training might discuss a case study among the full audience, facilitated by a presenter, and then break up into groups to debrief the case study and discuss possible approaches to it in greater detail. Group time could also be allotted for analyzing a set of graphs, or for reviewing a video, for example.

In such cooperative learning environments, managing the time spent on these group discussions can be problematic. Typically, the instructor will want the group discussion to proceed for a predetermined time to enable the groups to properly analyze and discuss the relevant concepts. However, the duration of the group discussion should also be short enough to allow the instructor to complete all of the seminar material.

One common audiovisual method employed with cooperative learning is the presentation of documents through the use of slides. Typically, a projector is used, which projects the graphical user interface of a laptop computer onto a viewing screen at the front of the classroom. These slides, shown in sequence, are generated by Powerpoint™ or other available software packages.

Another audiovisual method employed involves the use of multiple computers. The leader of the class or group discussion, while presenting, can display a document on her main computer. The main computer is networked with audience computers, on which the document image is also displayed. Such documents may be Powerpoint™ documents, MS Word™ documents, or documents that use other software packages.

Typically, seminar classrooms have clocks on the walls. However, group discussions begin at random times, and are difficult to start and stop using a clock. In addition, during group discussions, the attention of the students, and of the instructor, is focused on the topic being discussed, not on the clock. Under these circumstances, it is easy (and common) for the seminar participants to lose track of time, and for the group discussion to go well beyond its allotted time.

U.S. patent application number 2003/0122863, (“Dieberger”) discloses a navigation tool for slide presentations. The tool includes a visual display that helps the presenter navigate among the slides, and time information within the display that helps the presenter navigate among the slides. The time information includes the amount of the elapsed in the total presentation, and the amount of time remaining, as well as the average time available for each slide still remaining. Finally, the timing information can include a timer that shows how long the current slide has been displayed.

A problem with the method disclosed in Dieberger is that it does not assist the members of the groups in relation to their group discussions. Rather, its purpose is to help the presenter pace his/her presentation. For example, as described at paragraphs [0021] and [0035], the visual display that includes the timing information, and that overlays the slide, is “substantially transparent” and “does not significantly impede viewing of the current slide”. The visual display is “not intended to significantly detract form the attention paid to [the] current slide . . . by the audience”. Thus, in essence, the visual display showing time information is not for the benefit of the audience, who do not even notice it, but rather, for the presenter.

U.S. patent application no. 2004/0008221 (“O'Neal”) discloses a complex slide presentation system. The system includes a preview monitor (connected to a computer) for use by the presenter, and two other computer monitors connected to projectors so as to be visible to the audience.

O'Neal discloses at paragraph [0073] a clock icon 606 on the preview monitor that can be opened by the presenter as a timer window. The presenter can select a time period and display a timer that indicates the remaining time within that period.

However, like Dieberger, the time information in O'Neal is accessible to the presenter (on the preview screen), but not to the audience.

Another U.S. patent application, number 2002/0140724 (“Qureshi”) discloses timing information associated with slide presentations. However, like O'Neal, this information is visible only to the presenter, not the audience.

### SUMMARY OF THE INVENTION

Therefore, what is desired is a method and system for managing and/or conducting presentations or classes, in which the time remaining for group work is communicated to the audience. Therefore, according to one aspect of the invention, there is provided a method of managing a document presentation made by a presenter to an audience, the method comprising the steps of:
presenting a document image to the audience on a display apparatus;
positioning a timer image on the display apparatus so that the timer image overlays the document image at least partially, and so that the timer image is configured to be noticeably visible to the audience;
selecting a timer count duration to match a preselected duration of an audience group activity;
initiating a count of the timer;
updating the timer image in accordance with the count.

According to another aspect of the invention, there is provided a method of conducting a seminar that includes a slide presentation by a presenter to an audience, as well as periods of group work by the audience, the method comprising:
presenting a document image to the audience on a display apparatus;
determining the beginning of a period of group work;
positioning a timer image on the display apparatus so that the timer image overlays the document image at least partially, the timer image being configured to be noticeably visible to the audience;
selecting a timer count duration to match a preselected duration of an audience group activity;
initiating a count of a timer;
updating the timer image in accordance with the count;
perceiving a conclusion of the timer count;
terminating the period of group work in response to the conclusion of the count.

According to another aspect of the invention, there is provided a system for managing a presentation being made by a presenter to an audience, the system comprising:
a memory for storing computer-readable data;
one or more documents of said presentation stored in said memory;
an electronic controller, associated with the memory, for controlling the display of the one or more document images on a display apparatus;
a timer, associated with the electronic controller, the timer being configured to permit selection of a count duration and to have a count initiated;
wherein, the electronic controller and timer are configured to place a timer image on the display apparatus so as to be noticeably visible to the audience and at a position at least partially overlaying the document image, the timer being configured to update the timer image in accordance with the count.

### BRIEF DESCRIPTION OF THE DRAWINGS

The invention will now be illustrated by way of example only, in the attached drawings, which show the preferred embodiment of the invention, and in which:

FIG. 1 is a diagram showing a document presentation being presented;

FIG. 2 is a diagram showing a period of group work within the presentation;

FIG. 3 is a drawing of an example display apparatus showing an example document image and an example timer image;

FIG. 4 is a drawing of a laptop computer showing a document;

FIG. 5 is a close-up drawing of a graphical timer object;

FIG. 6 is a schematic diagram of an embodiment of the system;

FIG. 7 is a schematic diagram of a second embodiment of the system;

FIG. 8 is a diagram of a document presentation being presented in a classroom setting;

FIG. 9 is a drawing of a second example display apparatus showing an example document image and an example timer image; and

FIG. 10 is a drawing of a laptop computer showing a document.

### DETAILED DESCRIPTION OF THE PREFERRED EMBODIMENTS

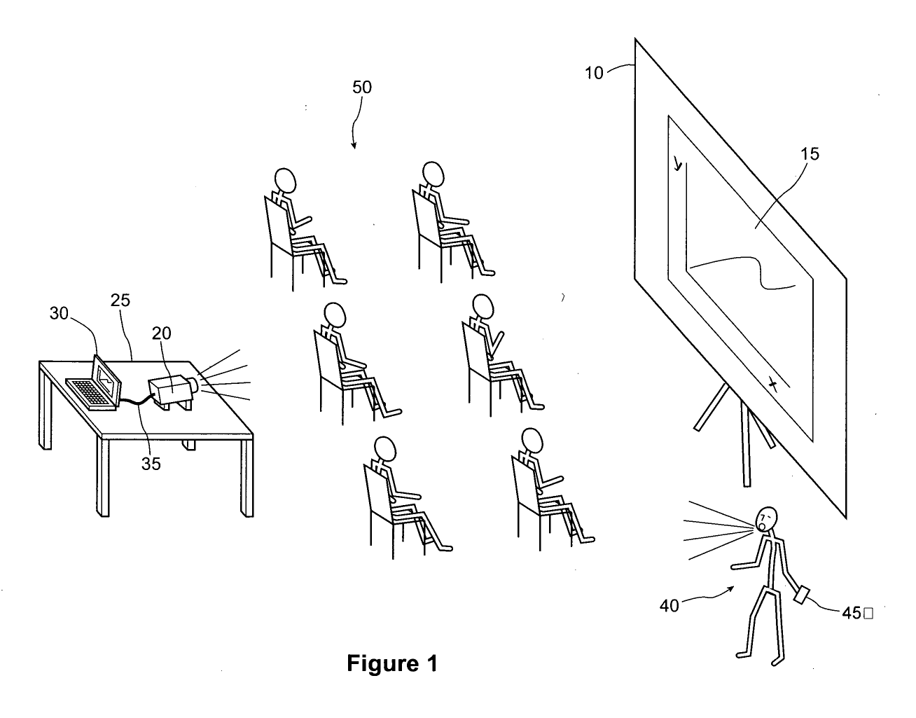

Referring now to FIG. 1, a slide presentation system is shown. The system includes a display apparatus, optionally in the form of a screen 10. On the screen 10 is a document image 15, which, in the illustrative example of FIG. 1, takes the form of an image of a graph. The document image 15 is projected onto the screen 10 by a projector 20 resting on the table 25. Also resting on the table 25 is a main computer, most preferably in the form of a laptop computer 30 which stores the documents to be projected onto the screen 10. The laptop 30 is associated with projector 20, preferably via cabling 35, and in the preferred embodiment, the laptop 30 has a memory which stores the one or more slides of the slide presentation.

The presenter 40 will typically hold a document presentation controller 45 in his hand. The controller 45 is used by the presenter 40 to scroll through the document presentation, showing each document of the presentation in turn. It will be appreciated that the preferred controller 45 can be used to scroll through successive documents of the presentation, either forwards or backwards.

Typically, the laptop 30 will be running PowerPoint™ or some other software (e.g. MS Word™) designed to create and/or display a presentation. Each document appears on the laptop 30 and is projected by the projector 20 such that a corresponding slide image 15 is displayed on the screen 10. The audience 50 is positioned so as to be able to see the document images 15 as they are displayed on the screen 10.

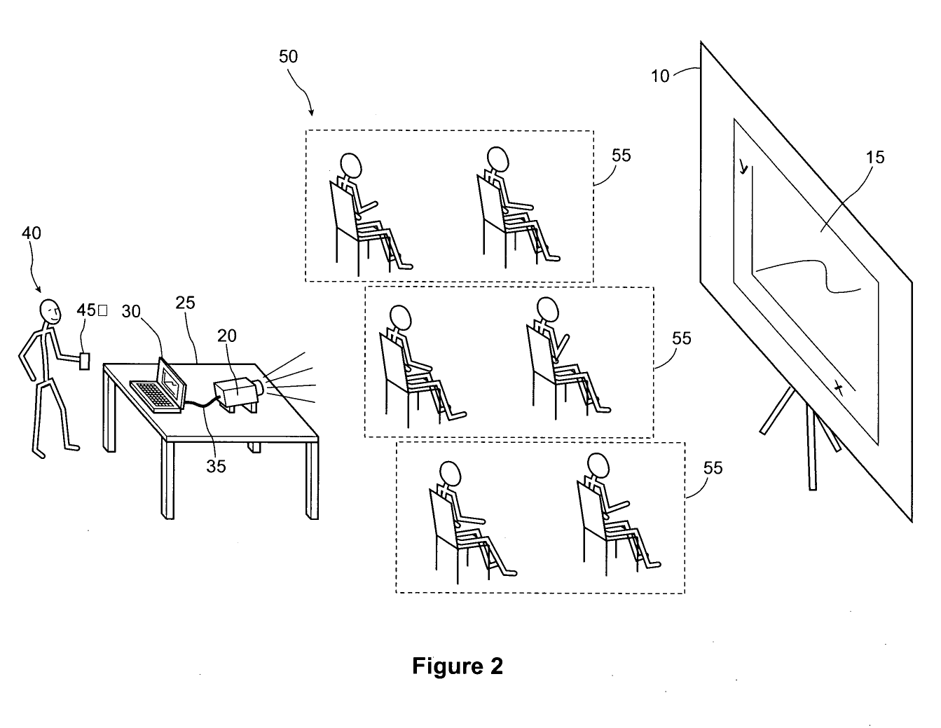

Referring now to FIG. 2, a situation is depicted in which the audience 50 has divided into audience groups 55 to discuss the subject matter of a particular document image 15. In a cooperative learning environment, the groups 55 are given a particular amount of time to discuss an issue within the groups. Then, the presenter resumes speaking to the audience as a whole.

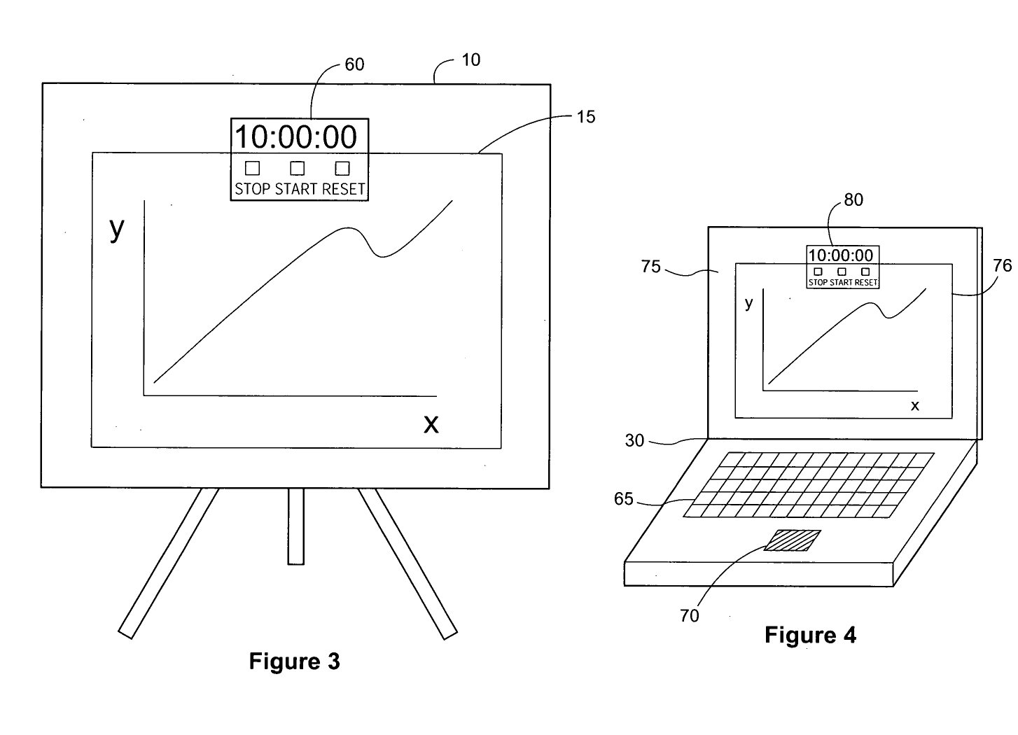

Referring now to FIG. 3, a screen 10 is shown on which a document image 15 is displayed, preferably by means of a projector 20 (not shown). Also shown is a timer image 60, which shows a timer count duration, i.e. the time remaining in a count. The count may comprise a countup or a countdown. The timer image 60 partially overlays the slide image 15.

FIG. 4 shows the laptop 30. The laptop 30 has a keyboard 65, a mouse 70, and a graphical user interface, preferably in the form of a laptop screen 75. Displayed on the screen 75 is a document 76 corresponding to the document image 15 displayed on the screen 10. Also displayed on the screen 75 is a graphical timer object 80.

It will be appreciated that in the preferred system for showing documents, documents stored in the computer-readable memory of the laptop 30 are displayed on the screen 75. The laptop 30 is connected to via cabling 35 to the projector 20, which projects onto the screen 10 an image 15 of the document 76 being shown on the screen 75. Similarly, the projector 20 projects onto the screen 10 the timer image 60, which is an image of the graphical timer object 80 displayed on the screen 75.

In operation, the presenter will preferably conduct a seminar, which seminar includes a document presentation and periods of group work within the groups 55, as follows. The presenter 40 presents the presentation to the audience 50, advancing the presentation using the controller 45. The controller 45 is preferably a remote controller (wired or wireless) that is in communication with the laptop 30. Actuating the controller 45 causes the laptop 30 to advance to the next document 76 within the presentation. The documents 76 of the slide presentation are preferably stored as computer-readable data within the memory of the laptop 30. The laptop 30, including both its hardware (CPU, memory, etc.) and any relevant software, most preferably together with the controller 45, functions as an electronic controller associated with the memory for controlling the display of the documents 76 of the presentation on the screen 10.

Preferably, the presenter will present a document image to the audience 50 on the screen 10 that is to be the subject of work within the groups 55. In a cooperative learning environment, the presenter will preferably discuss the content of the displayed document image 15, and then determine the beginning of a period of group work.

To effectively manage and conduct the seminar, it is beneficial that the actual duration of the period of group work be confined to its allotted time. In a typical presentation, there is a specified amount of material to deal with, and the presenter will be much less likely to successfully complete all of the material if the periods of group work go beyond their allotted time.

Therefore, preferably, the timer image 60 is positioned on the screen 10 so that the timer image 60 overlays the document image 15 at least partially. In other words, at least part of the document image 15 is covered by the timer image 60. Furthermore, the timer image 60 that is positioned on the screen 10 is configured to be noticeably visible to the audience. Thus, the timer image 60 is configured to be clearly visible to, and attract the attention of, the audience 50. Most preferably, the timer image 60 has a brightness level, and a colour composition, which causes it to stand out from the document image 15. Thus, when the audience 50 looks at the screen 10, the timer image 60 will be noticeably, strikingly, and/or clearly visible to the members of the audience 50.

It will be appreciated that the timer image 50 being noticeably and clearly visible to the audience, and being positioned so as to overlay the document image 15 at least partially, provides desirable time-related feedback to the groups 55 that are engaged in group work. After a timer count duration is selected to match a preselected duration for the group activity, and after the timer count is initiated, members of the groups 55 can keep track of how much time is left for them to complete the group work by simply viewing the timer image 60 on the display apparatus. This in turn helps the groups 55 to pace themselves throughout the period of group work and complete the group work within the preselected duration of the group activity. This reduces the pressure on the presenter to allow the group activity to continue beyond the time allotted.

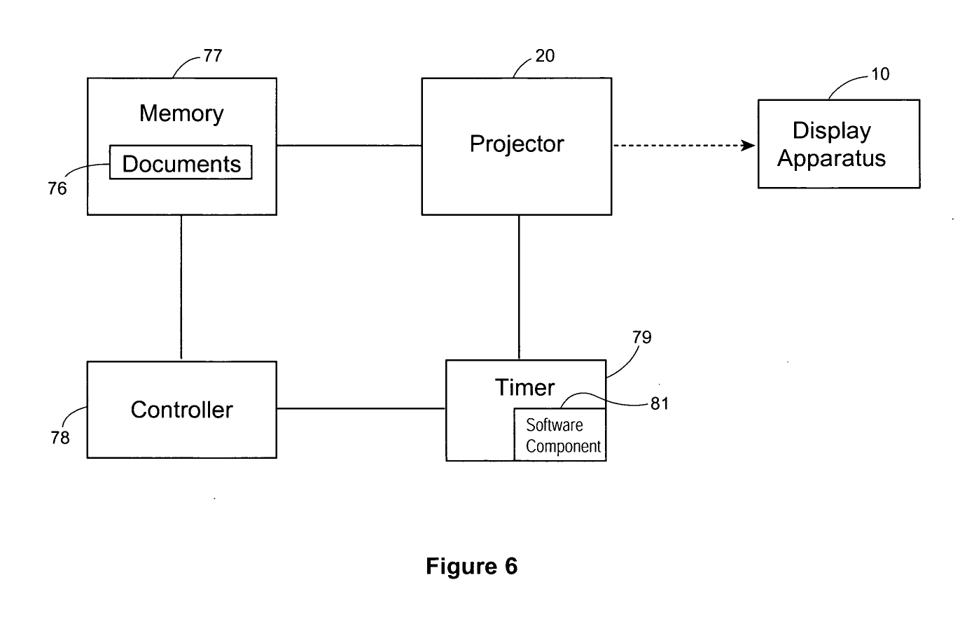

FIGS. 1-6 show one embodiment of a system for managing a document presentation being made by the presenter 40 to the audience 50. FIG. 6 shows a schematic diagram of this embodiment. The system includes a memory 77 for storing computer readable data, preferably in the form of the memory 77 contained within the laptop 30. A document presentation, which includes one or more documents 76, is stored within the memory 77. The laptop 30 is programmed to display documents 76 on the screen 75.

The projector 20 is associated with the memory 77 of the laptop 30, preferably by means of the cabling 35 which is plugged into both the projector 20 and laptop 30. The projector 20 functions to project the document image 15 onto the display apparatus, which display apparatus, in this embodiment, takes the form of the screen 10. It will be appreciated that the projector 20 is preferably configured to project onto the screen 10 an image of whatever material is being displayed on the graphical user interface 75 of the laptop 30.

The system also preferably includes an electronic controller 78, associated with the memory 77, for controlling the display of one or more documents 76 on the display apparatus. In the system shown, the laptop 30 functions as the electronic controller 77. It will be appreciated, therefore, that the preferred electronic controller comprises a programmable computer (such as the laptop 30) that has a CPU and graphical user interface 75. Also, in the embodiment of FIGS. 1-6, the electronic controller further includes the document presentation controller 45 used by the presenter 40 to advance or scroll backwards through the presentation.

The system further comprises a timer 79, associated with the projector 20 (in the embodiment of FIGS. 1-6) and the controller 78. The timer 79 is configured to permit selection of a count duration, and to have a count initiated.

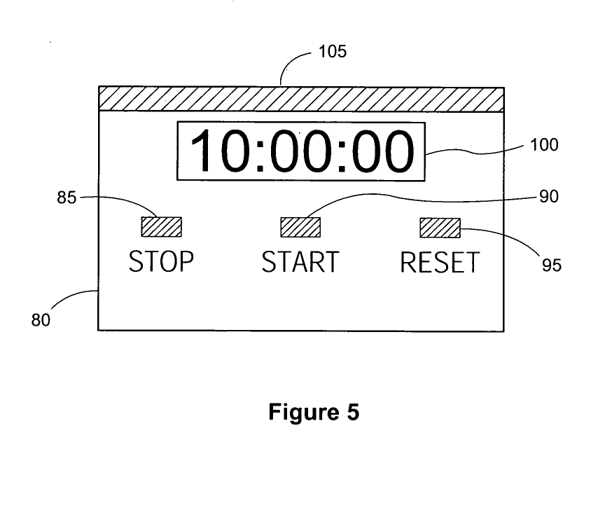

In the preferred embodiment, the timer 79 includes the laptop 30, together with a software component 81 installed on the laptop 30, executing in association with the laptop 30, and configured to permit both selection by a user of a count duration, and initiation of the count. As shown in FIGS. 4-5, in the most preferred embodiment, the presenter can initiate the timer software component 81, which is most preferably a Microsoft™ Windows™ based software component, by using the mouse 70. Upon actuation of the timer software component 81, the graphical timer object 80 shown in FIG. 5 will appear on the screen 75. In the example of FIG. 5, a ten-minute countdown duration is shown, but it will be appreciated that the component 81 is configured so that the user can select the duration of the count, preferably by entering the desired time using the keyboard of the laptop 30. Also, as shown in FIG. 5, the preferred graphical timer object 80 has three buttons that are actuatable using the mouse 70 of the laptop 30. These buttons are the stop button 85, the start button 90, and the reset button 95. The user can initiate the countdown by using the mouse of the laptop 30 to click on the start button 90. If desired, the countdown can be stopped by clicking on the stop button 85, and the time shown can be reset by clicking on the reset button 95. In response to initiation of the count, the timer software component 81 within the laptop 30 begins the timer count, preferably using the internal clock of the laptop 30. The laptop 30 updates the count display 100 in accordance with the count, so that the count display 100 accurately indicates the state of the count. Preferably, the count display 100 is updated more often than once every second, so that the count display 100 will be precise within a range of one second. However, it will be appreciated that lower or higher levels of precision are also comprehended by the invention. For example, the count display 100 could be updated once every five seconds, and still provide adequate (though less preferred) timing information to the audience 50.

The projector 20, electronic controller 78, and timer software component 81 are configured to permit the timer image 60 to be placed on the display apparatus at a position at least partially overlaying the document image 15 so as to be noticeably visible to the audience 50. It will be appreciated that this may be accomplished by the user of the laptop dragging the graphical timer object 80 to a position on the screen 75 wherein the graphical timer object 80 at least partially overlays the document 76. The material on the screen 75 is displayed on the display apparatus. Thus, when the graphical timer object 80 is positioned so as to at least partially overlay the document 76, the timer image 60 is automatically positioned on the display apparatus so as to at least partially overlay the document image 15. The graphical timer object 80 may be dragged by the user to its desired position using the mouse 70 of the laptop 30, by means of the drag bar 105 that is preferably positioned across the top of the graphical timer object 80.

It will be appreciated that the timer 79 is preferably configured so that the graphical timer object 80 can be selectively moved from a position at which it does not at least partially overlay the document 76 to a position at which it does at least partially overlay the document 76. Thus, the timer image 60 can be positioned in its desired position by a two-step process. First, it can be positioned on the display apparatus at a position where it does not at least partially overlay the document image 15. It can then be moved to a position on the display apparatus at which it does at least partially overlay the document image 15. It will be appreciated that this feature provides flexibility to the presenter during the period of group work. If, for example, during the period of group work, the presenter wishes to briefly make a comment on the current document 76, and wishes to briefly remove the timer image 60 from overlaying the document image 15, the presenter can position the timer image 60 at a position where it does not at least partially overlay the document image 15 and then move it to a position where it does at least partially overlay the document image 15 once the brief comment is concluded.

Once the timer image shows that the count has been completed, the audience 50 and the presenter 40 can both perceive a conclusion of the timer counted and, in response to said conclusion, terminate the period of group work. The presenter may then continue the document presentation.

It will be appreciated that the timer 79 and the timer software component could take the form of a stand-alone timer, or, it could also take the form of an embeddable object. When the timer is in stand-alone mode, in a typical Windows™ environment, it is typically configured as a separate object from the software (e.g. PowerPoint™, Keynote™ etc.) used to make, store and display the documents. In stand-alone mode, the object 80 sits on the desktop displayed on the screen 75, and can be imported into the window in which the document software (e.g. PowerPoint™, Keynote™ etc.) displaying the document, but is not saved as a file associated with the document software. In stand-alone mode, the buttons 85, 90, 95 will be responsive anytime the cursor is positioned above them and clicked.

When the timer 79 takes the form of an embeddable object, it is, by contrast to stand-alone mode, saved as a file that is imported into the document software program as it operates. In this mode, the user would set the timer, visual background, sounds, etc. of the timer and save the file (preferably on the latptop 30) so that it could be used. The saved file is then imported into the document software program, and actuated, via the mouse of the laptop 30, or via the controller 45. The object 80 then functions as a file embedded within the document software program, in a manner analogous to Adobe™ Acrobat™ or Quicktime™ functioning within Microsoft™ Internet Explorer™. In embeddable mode, because the timer settings are saved in advance, the buttons 85, 90, 95 of the object 80 are preferably not active or responsive during the count, and the timer preferably cannot be stopped, started or reset after actuation until the count is complete.

Also preferably, the timer 79, and in particular, the timer software component 81, are configured to permit notification sounds to be sounded at any chosen point in the count. Thus, for example, a notification sound can be set for one minute prior to the end of the count, and another for the end of the count. Preferably, a variety of different sounds is available as well. For example, a two-beep notification sound can be used as a warning sound when one minute (or some other predetermined amount of time) is left, and a single long beep used when the countdown is complete. Other types of sounds, and other timing choices for them, are also comprehended by the invention.

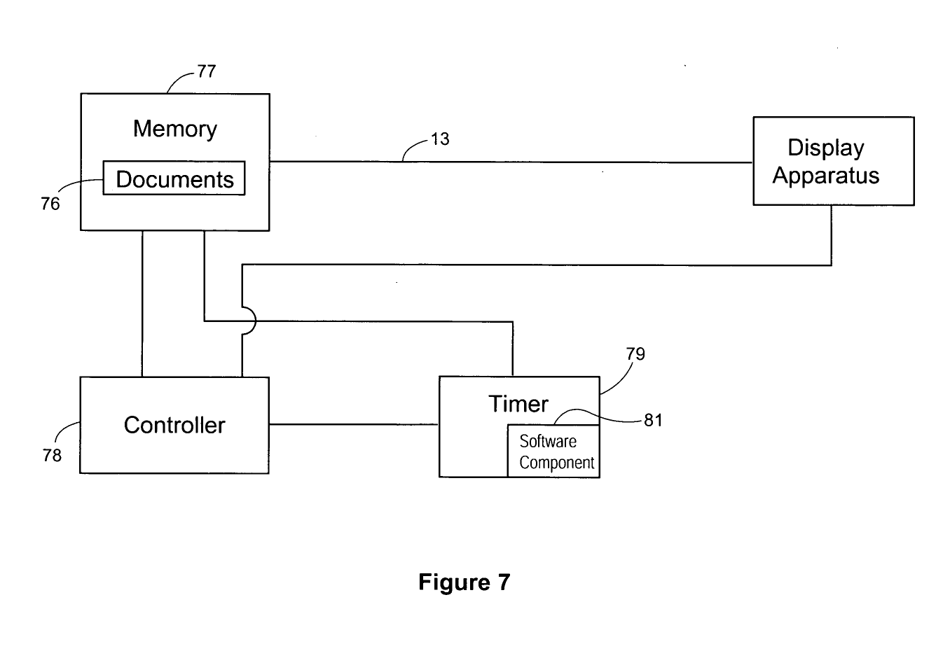

FIGS. 7-10 show another embodiment of the invention. The embodiment of FIGS. 7-10 functions generally similarly to the embodiments of FIGS. 1-6, with the differences discussed below.

It will be appreciated that the display apparatus may take any form which permits display of document image 15. In the embodiment of FIGS. 7-10, the display apparatus takes the form of one or more audience computers 200, each having screen 202. In this embodiment, the audience may, for example, comprise students in a classroom, each of whom has a computer 200. It will be appreciated that this configuration is particularly useful in cases where, during periods of individual or group work, it is desired for audience members to be able to use computers for that work.

It will further be appreciated that the invention does not limit the display apparatus to a single display unit, such as a single projection screen 10. Rather, the display apparatus may comprise multiple display units, such as, for example, multiple computers 200 each having an audience computer screen 202.

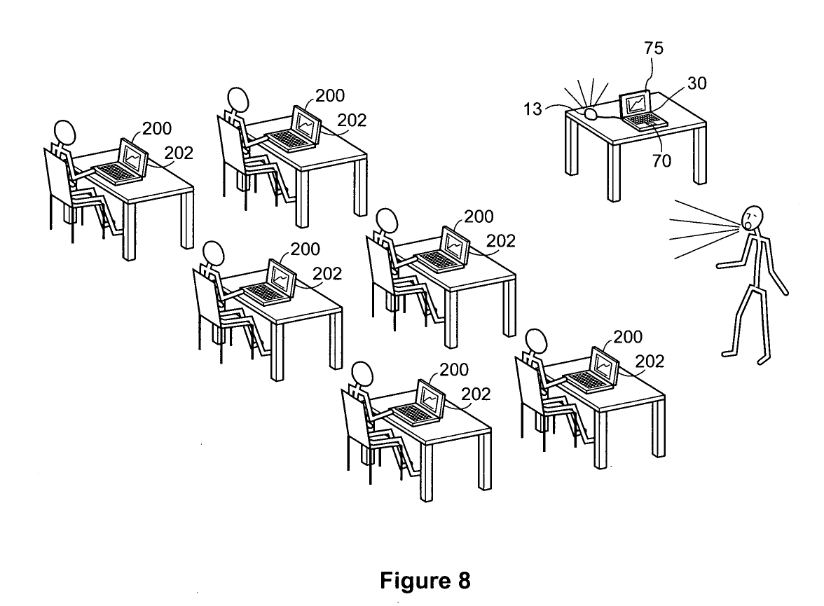

As shown in FIGS. 7 and 8, in this embodiment, the main computer 30 (typically used by the presenter) is typically connected by a wired or wireless network 13 to computers 200. The memory 77 stores documents 76, and is connected both to the computers 200 (via network 13), and to the laptop 30, which in this embodiment functions as controller 78. The timer 79, including software component 78. The timer 79, including software component 81, are preferably associated with both the controller 78 and memory 77.

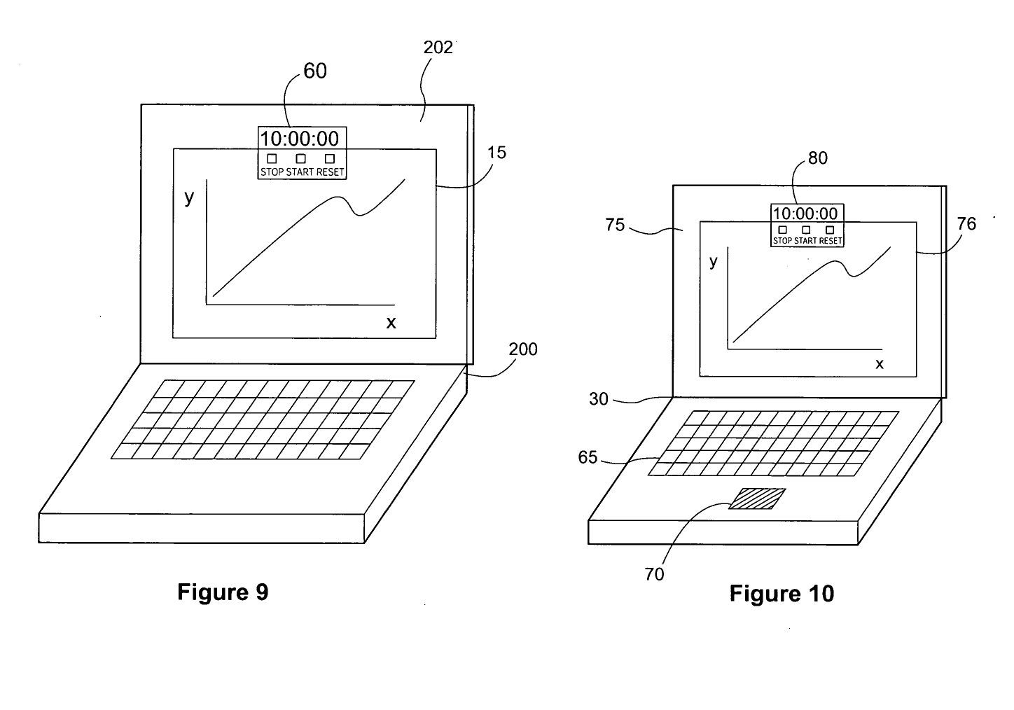

Thus, in this embodiment, the document image 15 is displayed on screens 202 by means of the computer 30 communicating document 76 to computers 200 via network 13. Similarly, graphical timer object 80, which appears on screen 75 of laptop 30, is moved by mouse 70. The network 13 is used to communicate the timer image to computers 200. Thus, when graphical timer object 80 is moved, timer image 60 is moved correspondingly on screens 202. Thus, the timer image 60 can be moved to and from positions that overlay document image 15. In this embodiment, FIGS. 9 and 10 show timer image 60 partially overlaying document image 15 on screen 202, and object 80 partially overlaying document 76 on screen 75.

While the foregoing embodiments of the present invention have been set forth in considerable detail, it will be apparent to those skilled in the art that various modifications can be made to the invention without departing from the scope of the attached claims. Some of these variations are discussed above and others will be apparent to those skilled in the art. For example, electronic controller may take a different form than the preferred form described above, as may the timer, memory projector and slide presentation, and still be comprehended by the invention. What is important is that the time remaining for group work be available to the audience.

The embodiments of the invention in which an exclusive property or privilege is claimed are defined as follows:

1. A method of managing a document presentation made by a presenter to an audience, the method comprising the steps of:
presenting a document image to the audience on a display apparatus;
positioning a timer image on the display apparatus so that the timer image overlays the document image at least partially, and so that the timer image is configured to be noticeably visible to the audience;
selecting a timer count duration to match a preselected duration of an audience group activity;
initiating a count of the timer;
updating the timer image in accordance with the count.

2. A method as claimed in claim 1, wherein the positioning step comprises the steps of positioning the timer image on the display apparatus so that it does not overlay the document image, and then moving the timer image to a position on the display apparatus wherein the timer image overlays the document image at least partially.

3. A method as claimed in claim 1, wherein the presenting step comprises presenting the document image on the display apparatus using a computer that is displaying a document corresponding to the document image.

4. A method as claimed in claim 3, wherein the positioning step comprises using the computer to position a graphical timer object on a graphical user interface of the computer at a position at least partially overlaying the document, and positioning the timer image at a corresponding position on the display apparatus.

5. A method as claimed in claim 2, wherein the presenting step comprises presenting the document image on the display apparatus using a computer that is displaying a document corresponding to the document image.

6. A method as claimed in claim 2, wherein the step of selectively repositioning comprises the step of selectively re-positioning the timer image after the initiating step has been completed.

7. A method as claimed in claim 1, wherein the updating step includes updating the timer image more often than once every second.

8. A method as claimed in claim 1, wherein the timer image is configured, by its brightness and colour, to be noticeably visible to the audience.

9. The method as claimed in claim 3, wherein the presenting step comprises using a projector to display a graphical user interface of the computer.

10. The method as claimed in claim 3, wherein the display apparatus comprises at least one audience computer, and wherein the presenting step comprises communicating with the at least one audience computer so as to cause the at least one audience computer to display the document image.

11. The method as claimed in claim 4, wherein the step of positioning on the display apparatus comprises using a projector to display the graphical user interface on the display apparatus.

12. The method as claimed in claim 4, wherein the step of positioning on the display apparatus comprises communicating with at least one audience computer such that the timer image is positioned on the at least one audience computer.

13. A method of conducting a seminar that includes a document presentation by a presenter to an audience, as well as periods of audience time, the method comprising:
presenting a document image to the audience on a display apparatus;
determining the beginning of a period of group work;
positioning a timer image on the display apparatus so that the timer image overlays the document image at least partially, the timer image being configured to be noticeably visible to the audience;
selecting a timer count duration to match a preselected duration of an audience group activity;
initiating a count of a timer;
updating the timer image in accordance with the count;
perceiving a conclusion of the timer count;
terminating the period of group work in response to the conclusion of the count.

14. A method as claimed in claim 13, wherein the presenting step comprises presenting the document image on the display apparatus using a computer that is displaying a document corresponding to the document image.

15. A method as claimed in claim 14, wherein the positioning step comprises using the computer to position a graphical timer object on a graphical user interface of the computer at a position at least partially overlaying the document, and positioning the timer image at a corresponding position on the display apparatus.

16. A method as claimed in claim 13, wherein the method further comprises the step of selectively re-positioning the timer object from a position on the display apparatus at which the timer image does not overlay the document image at least partially to a different position on the display apparatus at which the timer image overlays the document image at least partially.

17. A system for managing a presentation being made by a presenter to an audience, the system comprising:
a memory for storing computer-readable data;
one or more documents of said presentation stored in said memory;
an electronic controller, associated with the memory, for controlling the display of the one or more document images on a display apparatus;
a timer, associated with the electronic controller, the timer being configured to permit selection of a count duration and to have a count initiated;
wherein, the electronic controller and timer are configured to place a timer image on the display apparatus so as to be noticeably visible to the audience and at a position at least partially overlaying the document image, the timer being configured to update the timer image in accordance with the count.

18. A system as claimed in claim 17, wherein the electronic controller comprises a programmable computer configured to cause to be displayed on the display apparatus the material being displayed on a screen of the programmable computer.

19. A system as claimed in claim 18, wherein the timer includes a software component, executing in association with said computer, and configured to cause the computer to start a count of a selected duration.

20. A system as claimed in claim 19, wherein the programmable computer is programmed to display a document from the memory on a screen of the programmable computer so that the electronic controller will cause to be displayed a document image on the display apparatus.

21. A system as claimed in claim 20, wherein the software component is configured to place a graphical timer object on the screen at a position at least partially overlaying the document being displayed on the screen.

22. A system as claimed in claim 21, wherein the software component is configured to update the graphical timer object in accordance with the count.

23. A system as claimed in claim 20, wherein the software component is configured to update the graphical timer object more often than once every second.
